(19) United States
(12) Patent Application Publication
(10) Pub. No.: US 2020/0398313 A1
(43) Pub. Date: Dec. 24, 2020

(54) SET OF MARKING ARRAYS, METHOD FOR SORTING OBJECTS, AND SET OF OBJECTS THUS OBTAINED

(71) Applicant: Quickmail AG, St. Gallen (CH)

(72) Inventor: Christof Peter LENHARD, Kehrsatz (CH)

(21) Appl. No.: 16/970,978

(22) PCT Filed: Mar. 27, 2019
(86) PCT No.: PCT/EP2019/057770

§ 371 Date: Aug. 19, 2020

(30) Foreign Application Priority Data
Mar. 28, 2018 (EP) 18164520.1

(51) Int. Cl. B07C 3/18; B07C 5/34

(52) U.S. Cl. CPC B07C 3/18; B07C 5/3412

(57) ABSTRACT

A marking system comprises a set of markings which distinguish themselves by different brightness grades. In this system, different brightness grades are also expressed by different colors (30), based on the different brightness impression of the colors to the bare eye and an additional convention where such an order is not clearly apparent. By combining different colors (30) and different brightness levels (35) within colors, the required number of grades can be obtained. The markings are advantageous in particular for manual sortation since they are recognizable without positioning the marking in a particular orientation, e.g. the reading direction of the sortation employees. Preferred applications of the markings are in the delivery of postal items, in particular parcels.

The present invention relates to a set of marking arrays according to the preamble of claim 1. It further relates to a method for sorting objects according to the preamble of the first method claim. Furthermore, the invention relates to a set of objects marked or sorted.

A parcel (or more generally a postal item, which includes other items to be dispatched, such as documents) is understood to mean one object or a plurality of objects wrapped in packaging material and intended to be transported from a sender to a recipient. In most European public and private parcel services, items having a weight of up to 31.5 kg and a maximum size of 120×60×60 cm³ are classified as parcels.

The delivery of parcels requires sorting them in several stages. Typically, there are three stages, but depending on the size of a country or the area of activity of a service provider, there may be more or less stages than these three.
In the first stage, the items delivered to a parcel service provider are sorted according to the depots from which the drivers deliver them to the recipients.
In the second stage, in these depots, the parcels are sorted according to rounds that are fixedly linked to drivers or vehicles in most cases.
In the third stage, the parcels are sorted within rounds according to the order in which the recipients are served (“delivery sequence”).

A distinction is to be made between the criteria by which parcels are sorted in the individual stages and the technical devices by which this sorting is carried out.

### Criteria for Parcel Sortation

First stage: sortation by depots
Depots are mostly numbered, but a sortation by name is also possible. Such names are determined by the location of the respective depots (i.e. location names) or by the area served from the depots (i.e. names of areas or compass directions).
The depot numbers or names may be printed on the respective parcels or they may only exist virtually as a result of the assignment of the address to a parcel during the automatic reading of the address.
Second stage: sortation by rounds
Rounds are mostly numbered, but a sortation by name is also possible. In the latter case, the names are determined by the areas served by the respective round. Depot numbers or names may be printed on the respective parcels or they may only exist virtually as a result of the assignment of the address to a parcel during the automatic reading of the address.
Third stage: sortation by delivery sequence
The delivery sequence (sequence of delivery in a round) may be translated into numbers, i.e. parcel no. 1 will be delivered first, parcel no. 2 second, etc. Today, in contrast to the first or second stages, these numbers are mostly not printed on the parcels, and often such numbers are not even stored virtually but only exist due to the fact that a driver delivers parcels in a usual sequence after having sorted them correspondingly.

Generally it is possible in all stages of parcel sortation to sort parcels manually. In the simplest case, a parcel is picked up by a person and laid down in a particular place, e.g. in a roll container destined for a given depot. This process may be assisted by conveyor belts.

In the first and second stages, parcels are often sorted by sorting systems where either the number of a destination is read, or a bar code from which the number of the destination is determined directly or indirectly, i.e. through the parcel ID number that is assigned to the bar code and tied to the recipient's address, from which in turn the destination address is derived.

Reasons for using sorting systems are the avoidance of labor costs, the physical strain resulting from lifting, carrying, and laying down heavy parcels, higher hourly capacities, and the prevention of sorting errors by human workers.

In the third stage, parcels are sorted exclusively manually, i.e. by human workers, by placing them on units such as pallets or roll containers or directly loading them into vehicles in the sequence of delivery.

It is therefore an object of the present invention to provide a set of marking arrays that allows an efficient sortation of objects by persons.

A corresponding set of marking arrays is defined in claim 1. The further claims indicate preferred embodiments, methods for sorting objects, and sets of objects marked and/or sorted.

Accordingly, a central point of the present invention consists in using markings that are clearly distinguishable with regards to their brightness. In particular, such markings offer the advantage of being distinguishable independently of the orientation of the marked object, in contrast e.g. to letters or number codes. In a preferred application, these markings are applied to labels which in turn are affixed to the objects. One possibility of producing the markings is by thermal printers, which allow high printing speeds. Color thermal printers have become available recently.

Another aspect that may be considered in the use of markings differing with regard to their brightness appearance is that they correspond to common experience. In a closed space such as the loading space of a delivery van, objects located at the back, i.e. further away from the door, are darker than those nearer to the door.

One aspect in the use of brightness graduations is that they need to be relatively significant in order to allow an unambiguous assignment by the bare eye. The number of graduations is thus substantially reduced, i.e. to at most 10 or even less, e.g. 5 or 4, as experience shows. This limitation can be overcome by additionally using colors. On one hand, different colors already represent a difference in brightness per se; thus, for example, the color yellow leaves a very bright impression while blue seems comparatively dark. By the additional use of clearly distinguishable colors, a two-dimensional brightness matrix can be achieved which still provides reliably distinguishable sorting criteria in a clear order by the bare eye.

The invention will be further explained by means of preferred exemplary embodiments and with reference to figures showing:

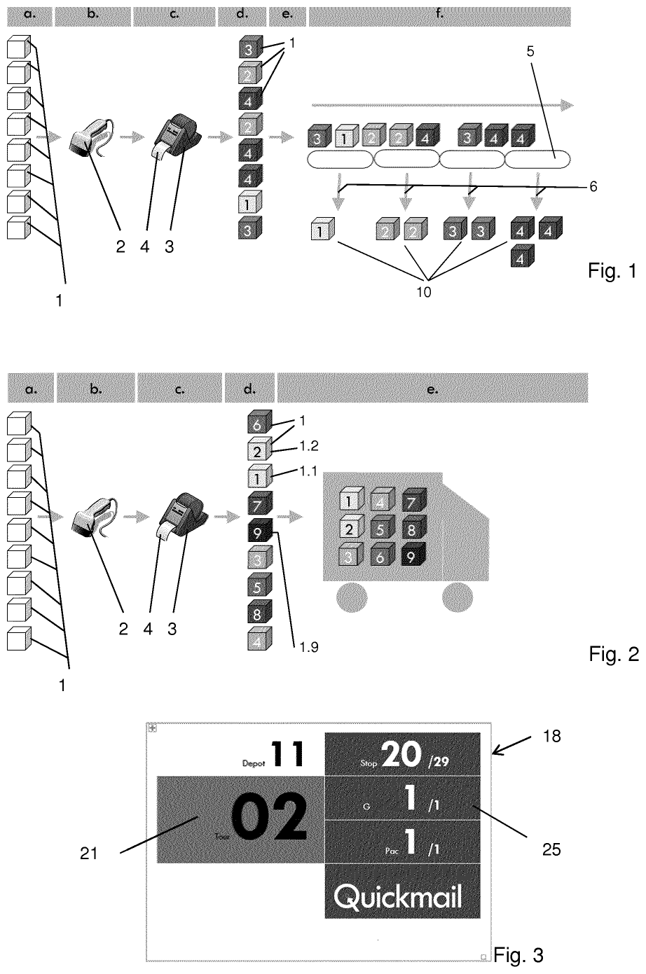

FIG. 1 a schematic illustration of a sortation in the first and second stages;

FIG. 2 a schematic illustration of a sortation in the third stage;

FIG. 3 an example of a marking;

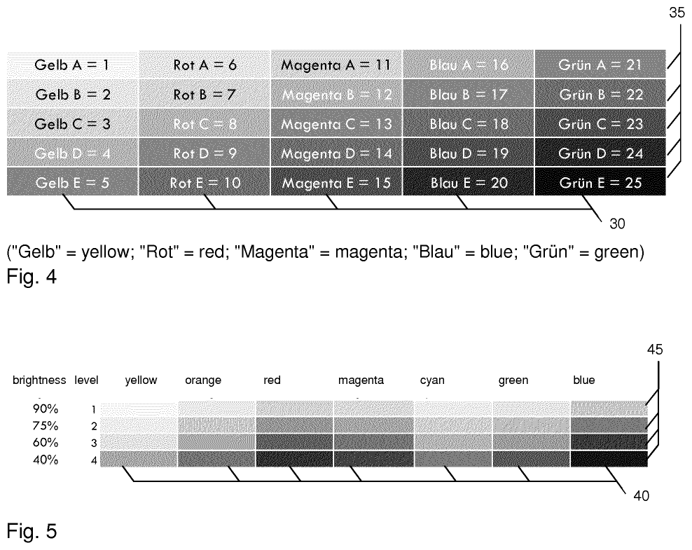

FIG. 4 a first variant of a brightness/color scheme; and

FIG. 5 a second variant of a brightness/color scheme.

One basis of the present invention is the brightness perception of the human eye. In particular, the question arises as to which brightness graduations are individually perceivable and distinguishable rather than in direct comparison. Regarding the perceptibility of an external stimulus, Ernst Heinrich Weber formulated Weber's Law in 1834:

$$K = \frac{Δ R}{R} \qquad ( Formula 1 )$$

R: stimulus,
ΔR: change of stimulus,
K: physiological difference.

For a perceivable difference in brightness, Weber indicates a value of K>1-2%, where R represents the light intensity. However, these values were determined in direct comparison of two brightness levels.

As a measure of brightness, light intensity may be used, which is obtained as the quotient of the radiant power by the spatial angle (steradian):

$$I = \frac{d Φ}{d Ω} \qquad ( Formula 2 )$$

I: intensity [W/sr]
ϕ: radiant power [W]
Ω: spatial angle [sr]

Accordingly, it is the ratio that determines the distinguishability of different brightness levels. However, a higher ratio is required for an attribution without a comparison before one's eyes. Empirically, a difference, i.e. a ratio of at least 15-20% has been found. In other words, the intensity ratio between a darker and a brighter sample is at most 0.85. Smaller factors of e.g. 0.75, 0.66 (⅔), or 0.5 are preferred in order to improve distinction and to ensure a reliable attribution to a given brightness level.

Logarithmic scales of this kind are e.g. defined for sRGB. According to this definition, the luminance (brightness value) for a greater intensity is represented by an ×^{1/2.4} relationship (cf. Wikipedia (wikipedia.org) under the keyword “RGB”).

For the purposes of the present invention, however, very few grades are preferably used in order to allow a reliable attribution by the bare eye. Therefore, as a lower limit, a representation that yields a reliably recognizable color impression is required. Likewise, at the highest value, i.e. at the upper limit of the brightness value, the color should still be recognizable. The available brightness range of the colors including these two limit values is divided into no more than 6 levels, more preferably 5 or 4 levels. For such a low number of grades, an even distribution can be chosen independently of whether the underlying scale is linear or entirely or partly logarithmic so as to comply with physiological findings or technical limitations.

Mixtures of linear and logarithmic scales, or generally scales between linear and logarithmic may also be used. Thus, for example, for sRGB, a linear relationship (Y=12.92 L) between color value Y and light intensity L is used at lower light intensities and a root function Y=1.055*L ^{1/2.4}−0.055 at higher light intensities.

### Sorting by Colored Labels in the First and Second Stages

FIG. 1 illustrates the method by an example of eight parcels 1 and four depots or rounds 10:
Parcels 1, which are provided with a bar code affixed by the sender and destined to be sorted, are prepared for their delivery. The bar code comprises an identification number that allows its assignment to the recipient's address.
The bar code is scanned 2. Based on the address, the depot or round to which the parcel belongs, the number of the depot or the round, and the color that corresponds to that number are determined.
By means of printer 3, a label 4 of the corresponding color (but also showing the number of the destination) is printed. In this example, “1” is the brightest color (e.g. yellow), “2” the second brightest color (e.g. red), “3” the second darkest color (e.g. green), and “4” the darkest color (e.g. blue). The numbers representing the colors are those indicated in FIG. 1 inside parcels 1.
Label 4 is affixed to the corresponding parcel 1.
Parcel 1 is placed on a conveyor belt 5.
Based on the color of the label, sortation employees 6 (symbolized by arrows) along the conveyor belt pick up the parcels that are intended for the destinations for which the respective sortation employees are responsible. In doing so, they heed the color of each label. Therefore, they are able to tell from a distance whether a parcel for their destination is approaching.

If the sortation employees miss a parcel, it is dropped at the end of the conveyor belt and returned to the beginning of the conveyor belt.

For a larger number of destinations, the system may be extended as follows:
A sortation employee is responsible for multiple destinations that are assigned to the same color but additionally distinguished by a number. For example, a sortation employee may be responsible for four destinations having the color “bright yellow”. Accordingly, he will pick up all parcels having a bright yellow label. For the four destinations, a number is additionally provided on the label by which the sortation employee will know to which one of the four destinations the parcel has to be directed.
Instead of one conveyor belt, two to four conveyor belts may be used which extend from the center in a star shape. In this case, the sortation employees who place the parcels on the conveyor belts will allocate them to these two to four conveyor belts based on a number. The advantage of this arrangement is that the entire color range is again available for each conveyor belt.

### Sorting by Colored Labels in the Third Stage

The sortation in the third stage serves to arrange the parcels in the order in which each driver assigned to a round delivers the parcels to the recipients. Typically, depending on the size and weight of the parcels and the size of the served area, the loading capacity of the vehicle, and the available time window, between 30 and 300 parcels are delivered.

In principle, the parcels are delivered by ascending numbers. Different variants are possible:
Numbering the parcels according to the number of the parcels
Numbering the parcels according to the number of the buildings (in this case, two parcels for the same building will have the same number)
Numbering the parcels according to the number of the stops (in this case, two or more parcels for at least two buildings that are served from the same parking location [=stop] will have the same number.)

The principle according to which colors are assigned to the numbers is applicable in all variants. Low numbers are preferably assigned a bright color and high numbers a dark color.

A prerequisite for this solution is that at the time of determining the delivery sequence, the addresses of all parcels for the respective round are known and the parcels are also physically present in the depot. This is ensured by scanning the ID codes of the corresponding parcels.

FIG. 2 illustrates the method by the example of a round including nine parcels 1. Except for parcel 1.9 having the number 9, each color is used for two parcels. The distinction between the two parcels of the same color is ensured by the number printed thereon. In this manner, the color allows the sortation employee to carry out a preliminary sorting whereas the final sortating is carried out by numbers.
a. Parcels 1, which are provided with a bar code and have already been sorted for a particular round, are ready for their delivery.
b. The bar code is scanned by means of a scanner 2. Based on the address, the order in which the parcels are delivered and the resulting delivery sequence number are determined. Parcel number “1” is delivered first, followed by parcel “2”, etc.
c. A label of the corresponding color (but also showing the number within the delivery sequence) is printed and affixed to the parcel. In this example, parcel 1.1 and parcel 1.2 bear the brightest color (yellow), and parcel 1.9 bears the darkest color (blue).
d. The label is affixed to the parcel.
e. The parcels with the label of darkest color are placed in the vehicle first, followed by the parcels having labels of brighter colors. In case of a large number of parcels it is also possible that the parcels are first sorted onto “parking locations” independently of their color.

If a sortation by colors has already been carried out in stage 1 or 2, there is already a colored label on the parcel. In this case, the solution described in this paragraph starts with d, and the label has to be provided with two color surfaces 21, 25 (see FIG. 3).

An advantage of this solution is that the sortation employee intuitively recognizes whether a parcel is at the end or at the beginning of the round. Certainly, this can also be expressed by numbers, i.e. by printing e.g. “parcel No. 101 of 127” on the parcel. Accordingly, this parcel belongs to the beginning of the last fifth of the round. However, to determine this from numbers is a significantly more demanding and time-consuming cognitive achievement than knowing that the parcel belongs to the last fifth of the round by the fact that it carries a green label and knowing that it is to be delivered at the beginning of this last fifth by the fact that it has a light green label.

### Using the Same Label for Multiple Sortation Stages

If the sorting of the parcels by colors is carried out for only one sorting stage in the entire delivery process, the labels have only one colored area.

If the sorting of the parcels by colors is carried out for at least two stages, label 18 is provided with two colored areas 21, 25. To ensure that the sortation employees can distinguish these colored areas, these have significantly different sizes, as the following example shows. Area 21 on the left indicates the sortation for stage 2 (with regard to rounds) and area 25 the sortation for stage 3 (with regard to the delivery sequence). A colored indication of the sortation for stage 1 (depot) has been omitted in this example.

### Distinguishable Colors

The human eye can only distinguish a limited number of printable colors. The suggested solution assumes that up to 25 printable colors can be used. To this end, first a division into five color groups is carried out (see FIG. 4), namely yellow, red, magenta, blue, and green. Then a graduation from bright to dark is carried out within these color groups, i.e. from light blue to dark blue, for example.

While the classification within one color group is readily understandable (e.g. light blue is brighter than dark blue and is therefore assigned to a lower number), the assignment to low and high numbers is not quite unambiguous with regard to the color groups. The only thing that is really clear is that the color group yellow is the brightest color, which is also seen by the fact that yellow always results in a brighter shade of grey on black and white representations than all other colors. The assessment of the brightness of the remaining colors requires a convention and thus a corresponding training of the sortation employees. To this end, the following relationships are established: Yellow is regarded brighter than red. Red is regarded brighter than magenta. Magenta is regarded brighter than green. Green is regarded brighter than blue.

This results in the arrangement of color groups and assignments to ascending numbers of FIG. 4. In this case, five grades 35 are provided in each of the five colors 30, thus resulting in 25 sortation levels.

A variant is illustrated in FIG. 5. Here a smaller number of brightness grades 40 is used in each color, namely 4, whereby a clearer distinction within colors is obtained. In compensation, a total of seven colors 45 are used, resulting in 28 grades. As is apparent from the grey levels, there is a natural brightness graduation for the colors yellow, orange, red, and blue. For the colors magenta, cyan, and green, however, a convention is required. To this end, a transition from red to blue is used as the guiding principle, whereby the order red, magenta, cyan, green, blue is obtained.

The colors are chosen as a function of the maximum distance in the color model. In particular, the primary colors of the RGB system (red, green, blue) and their mixed colors, i.e. yellow (red+green), cyan (green+blue), and magenta (red+blue) are suggested here. In addition, the clearly distinguishable color orange (red+green at approx. half the intensity) is used. As a result, the following table in the RGB system is obtained where only the brightness levels marked with numbers in the column “grade” are used.

TABLE
Brightness values in the RGB system

| Brightness | Grade | Yellow | Orange | Red | Magenta |
|---|---|---|---|---|---|
| 100% | | 255, 255, 255 | 255, 255, 255 | 255, 255, 255 | 255, 255, 255 |
| 95% | | 255, 255, 230 | 255, 245, 230 | 255, 230, 230 | 255, 230, 255 |
| 90% | 1 | 255, 255, 204 | 255, 235, 204 | 255, 204, 204 | 255, 204, 255 |
| 85% | | 255, 255, 179 | 255, 224, 179 | 255, 179, 179 | 255, 179, 255 |
| 80% | | 255, 255, 153 | 255, 214, 153 | 255, 153, 153 | 255, 153, 255 |
| 75% | 2 | 255, 255, 128 | 255, 204, 128 | 255, 128, 128 | 255, 128, 255 |
| 70% | | 255, 255, 102 | 255, 194, 102 | 255, 102, 102 | 255, 102, 255 |
| 65% | | 255, 255, 77 | 255, 184, 77 | 255, 77, 77 | 255, 77, 255 |
| 60% | 3 | 255, 255, 51 | 255, 173, 51 | 255, 51, 51 | 255, 51, 255 |
| 55% | | 255, 255, 26 | 255, 163, 26 | 255, 26, 26 | 255, 26, 255 |
| 50% | | 255, 255, 0 | 255, 153, 0 | 255, 0, 0 | 255, 0, 255 |
| 45% | | 230, 230, 0 | 230, 138, 0 | 230, 0, 0 | 230, 0, 230 |
| 40% | 4 | 204, 204, 0 | 204, 122, 0 | 204, 0, 0 | 204, 0, 204 |
| 35% | | 179, 179, 0 | 179, 107, 0 | 179, 0, 0 | 179, 0, 179 |
| 30% | | 153, 153, 0 | 153, 92, 0 | 153, 0, 0 | 153, 0, 153 |
| 25% | | 128, 128, 0 | 128, 77, 0 | 128, 0, 0 | 128, 0, 128 |
| 20% | | 102, 102, 0 | 102, 61, 0 | 102, 0, 0 | 102, 0, 102 |
| 15% | | 77, 77, 0 | 77, 46, 0 | 77, 0, 0 | 77, 0, 77 |
| 10% | | 51, 51, 0 | 51, 31, 0 | 51, 0, 0 | 51, 0, 51 |
| 5% | | 26, 26, 0 | 26, 15, 0 | 26, 0, 0 | 26, 0, 26 |
| 0% | | 0, 0, 0 | 0, 0, 0 | 0, 0, 0 | 0, 0, 0 |
| Brightness | Grade | Cyan | Green | Blue | Black |
| 100% | | 255, 255, 255 | 255, 255, 255 | 255, 255, 255 | 255, 255, 255 |
| 95% | | 230, 255, 255 | 230, 255, 230 | 230, 230, 255 | 242, 242, 242 |
| 90% | 1 | 204, 255, 255 | 204, 255, 204 | 204, 204, 255 | 230, 230, 230 |
| 85% | | 179, 255, 255 | 179, 255, 179 | 179, 179, 255 | 217, 217, 217 |
| 80% | | 153, 255, 255 | 153, 255, 153 | 153, 153, 255 | 204, 204, 204 |
| 75% | 2 | 128, 255, 255 | 128, 255, 128 | 128, 128, 255 | 191, 191, 191 |
| 70% | | 102, 255, 255 | 102, 255, 102 | 102, 102, 255 | 179, 179, 179 |
| 65% | | 77, 255, 255 | 77, 255, 77 | 77, 77, 255 | 166, 166, 166 |
| 60% | 3 | 51, 255, 255 | 51, 255, 51 | 51, 51, 255 | 153, 153, 153 |
| 55% | | 26, 255, 255 | 26, 255, 26 | 26, 26, 255 | 140, 140, 140 |
| 50% | | 0, 255, 255 | 0, 255, 0 | 0, 0, 255 | 128, 128, 128 |
| 45% | | 0, 230, 230 | 0, 230, 0 | 0, 0, 230 | 115, 115, 115 |
| 40% | 4 | 0, 204, 204 | 0, 204, 0 | 0, 0, 204 | 102, 102, 102 |
| 35% | | 0, 179, 179 | 0, 179, 0 | 0, 0, 179 | 89, 89, 89 |
| 30% | | 0, 153, 153 | 0, 153, 0 | 0, 0, 153 | 77, 77, 77 |
| 25% | | 0, 128, 128 | 0, 128, 0 | 0, 0, 128 | 64, 64, 64 |
| 20% | | 0, 102, 102 | 0, 102, 0 | 0, 0, 102 | 51, 51, 51 |
| 15% | | 0, 77, 77 | 0, 77, 0 | 0, 0, 77 | 38, 38, 38 |
| 10% | | 0, 51, 51 | 0, 51, 0 | 0, 0, 51 | 26, 26, 26 |
| 5% | | 0, 26, 26 | 0, 26, 0 | 0, 0, 26 | 13, 13, 13 |
| 0% | | 0, 0, 0 | 0, 0, 0 | 0, 0, 0 | 0, 0, 0 |

The brightness grades are the result of RGB increments of approx. 50 to 80 in a range of 512 grades (256 “pure” levels and 256 brighter levels by admixture, see below) per color, i.e. approx. 1/10 to ⅛ of such a range of grades, wherein the brighter levels are preferred because they are more clearly distinguishable. The mean brightness corresponds to the combination where at least one of the primary colors of which the respective color is composed attains its maximum intensity. Darker shades are created by equally increasing the intensity of the primary colors of which the color is composed, while brighter ones are created by equally admixing the primary colors that have no intensity at mean brightness.

As follows from the table, a distance of approx. one grade is maintained from the brightest value, i.e. from white, since this brightness level already yields a clearly recognizable color impression. In contrast, the darkest shade used is only barely below mean brightness since the color impression quickly tends to disappear into black and additionally a safety margin for unfavorable light conditions has to be taken into account.

The described markings and the corresponding marking method make it possible to manually arrange objects in an expeditious and reliable manner in the order of a delivery sequence that allows the shortest possible or least time-consuming route of a delivery vehicle. In this manner it is also possible even in small distribution stations to arrange the postal items on a support in such a manner that they can be loaded into a delivery vehicle directly and without being rearranged.

From the preceding description, variants and additions are conceivable to the one skilled in the art without leaving the scope of the invention which is defined by the claims. Thus, for example, the application of the invention in fields other than postal distribution may be contemplated where, on one hand, especially in the case of small quantities, a manual sortation is required due to the diversity of the objects to be sorted, but on the other hand, a sortation according to a defined order is necessary.

Furthermore, it may be conceived:
In addition to a color, a pattern may be used. The pattern may be a hatching that may symbolize a darker variant of the color. By a variation of the pattern, e.g. by parallel lines, crossed lines, waved lines, etc., further groups of brightness levels may be created. Possibly, a blank field for coding purposes is provided in the pattern. In addition, a pattern may have a contour, preferably one that is distinguishable at a glance, i.e. a polygon ranging from a triangle to at most a hexagon or better a pentagon, a circle, an oval, an ellipse. The contour may be a line in the colored field or a contour of the colored field. Furthermore, both features may be provided in parallel.
A set of marking arrays may comprise marking arrays of a single color, optionally in combination with a geometrical shape, and multiple brightness levels.

1. A set of marking arrays for marking objects, wherein each marking array comprises at least one allocation field that is provided with a manifestation of a brightness level, said manifestation is composed of a color and optionally of a pattern, and a respective manifestation in conjunction with a respective brightness level is assigned to a destination such that an object can be assigned to that destination by affixing a marking array of the set of marking arrays.

2. The set of marking arrays according to claim 1, wherein at least one color, preferably all colors, are provided in brightness levels L corresponding to at most 10 levels from minimum to maximum brightness, or by increasing preference in at most 8, 7, or 6 levels, wherein the respective brightest and darkest level substantially corresponds to white and black, respectively.

3. The set of marking arrays according to claim 2, wherein the brightness levels are distributed at substantially equal distances on a brightness scale of the respective color, the brightness scale being a linear scale, a logarithmic scale, or a scale having an intermediate characteristic therebetween in order to ensure their distinction by the bare eye.

4. The set of marking arrays according to claim 1, wherein at most 8 colors, increasingly preferably at most 7, 6, or 5 colors, are provided.

5. The set of marking arrays according to claim 4, wherein the colors are at least one, preferably all, of three primary colors, the three primary colors yielding either white in the case of additive mixing or black in the case of subtractive mixing.

6. The set of marking arrays according to claim 5, wherein additionally at least one color is provided that is a 1:2 mixture or a 1:1 mixture of two primary colors according to brightness values, and in that preferably all colors are primary colors or such mixtures.

7. The set of marking arrays according to claim 1, wherein the allocation field has a surface area of at least 9 cm², preferably at least 16 cm², and more preferably at least 20 cm² in order to provide a clear distinction by the bare eye.

8. The set of marking arrays according to claim 1, wherein a first and a second allocation field are provided, the first allocation field being at least 50%, preferably at least 75%, and more preferably at least 100% larger in at least one dimension than the second one.

9. The set of marking arrays according to claim 1, wherein the marking arrays are applied to a carrier, preferably a self-adhesive carrier.

10. A method for sorting a number of objects, wherein each object is provided with at least one allocation field of a marking array of the set of marking arrays according to claim 1.

11. The method according to claim 10, wherein the objects are arranged in view of being removed according to a predetermined sequence and starting from one end of that sequence, a respective allocation field having an increasingly darker marking corresponding either to a later or an earlier removal, and the used colors indicating, according to a convention with regard to their brightness, an order of a higher or a lower level than the order by brightness.

12. The method according to claim 11, wherein the order of at least two colors corresponds to the brightness impression of those colors to the bare eye.

13. A set of objects provided with respective marking arrays according to claim 1.

14. The set of objects according to claim 13, wherein the marking arrays are printed on respective labels and the labels are affixed to the surface of the respective objects.

15. The set of objects according to claim 13, wherein the objects are parcels being transported to a recipient.

16. A set of objects sorted according to claim 10.

17. The set of objects according to claim 16, wherein the marking arrays are printed on respective labels and the labels are affixed to the surface of the respective objects.

18. The set of objects according to claim 16, wherein the objects are parcels being transported to a recipient.
